(19) United States
(12) Patent Application Publication
(10) Pub. No.: US 2006/0167091 A1
(43) Pub. Date: Jul. 27, 2006

(54) Acaricide

(76) Inventors: Naoki Ishii, Naruto-shi (JP); Yasuhiro Sasama, Naruto-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/547,630

(22) PCT Filed: Mar. 1, 2004
(86) PCT No.: PCT/JP04/02481

§ 371 Date: Sep. 1, 2005

(30) Foreign Application Priority Data
Mar. 12, 2003 (JP) 2003-066330

(51) Int. Cl. A01N 37/34

(52) U.S. Cl. 514/522

(57) ABSTRACT

The present invention provides a miticide that brings about a significantly remarkable mite controlling effect over a long period of time. The miticide of the present invention contains (a) an acylacetonitrile compound represented by Formula (1): 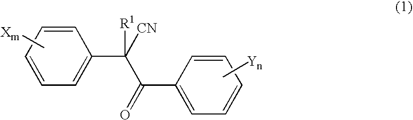
wherein R¹ is —C(O)ZR²; R² is a C₁₋₆ alkyl, C₁₋₄ haloalkyl, C_{2-4 alkenyl, C}₂₋₄ alkynyl, (C₁₋₆ alkoxy)C₁₋₄ alkyl, (C₁₋₄ alkylthio)C₁₋₄ alkyl, or benzyl group; Z is an oxygen or sulfur atom; X and Y independently represent a halogen atom or a C₁₋₆ alkyl or C₁₋₄ haloalkyl group; m and n independently represent an integer from 1 to 3; and each m X's and each n Y's may be the same or different, and (b) chlorfenapyr.

### TECHNICAL FIELD

The present invention relates to a miticide.

### BACKGROUND ART

Some mites have recently developed resistance to miticides that have been in use for many years, making it difficult to control them with conventional miticides. Thus, there are demands for the development of a novel miticide.

### DISCLOSURE OF THE INVENTION

The inventors conducted extensive research in response to such demands and have succeeded in developing an acylacetonitrile compound that brings about an excellent mite controlling effect (Japanese Unexamined Patent Publication No. 2002-121181). This acylacetonitrile compound is represented by Formula (1): 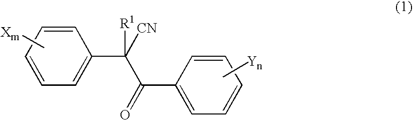
wherein R¹ is —C(O)ZR²; R² is a C₁₋₆ alkyl, C₁₋₄ haloalkyl, C₂₋₄ alkenyl, C₂₋₄ alkynyl, (C₁₋₆ alkoxy)C₁₋₄ alkyl, (C₁₋₄ alkylthio)C₁₋₄ alkyl, or benzyl group; Z is an oxygen or sulfur atom; X and Y independently represent a halogen atom or a C₁₋₆ alkyl or C₁₋₄ haloalkyl group; m and n independently represent an integer from 1 to 3; and each m X's and each n Y's may be the same or different.

### DISCLOSURE OF THE INVENTION

The inventors conducted further research to develop a miticide that produces an enhanced mite controlling effect and found that the use of an acylacetonitrile compound represented by the aforementioned Formula (1) and chlorfenapyr in combination results in a significantly enhanced mite controlling effect. The present invention has been accomplished based on this finding.

1. A miticide comprising:

(a) an acylacetonitrile compound represented by Formula (1): 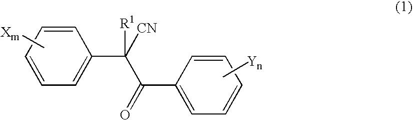
wherein R¹ is —C(O)ZR²; R² is a C₁₋₆ alkyl, C₁₋₄ haloalkyl, C₂₋₄ alkenyl, C₂₋₄ alkynyl, (C₁₋₆ alkoxy)C₁₋₄ alkyl, (C₁₋₄ alkylthio)C₁₋₄ alkyl, or benzyl group; Z is an oxygen or sulfur atom; X and Y independently represent a halogen atom or a C₁₋₆ alkyl or C₁₋₄ haloalkyl group; m and n independently represent an integer from 1 to 3; and each m X's and each n Y's may be the same or different, and

(b) chlorfenapyr.

2. The miticide according to item 1, wherein the acylacetonitrile compound is a compound represented by Formula (1) wherein Z is an oxygen atom.

3. The miticide according to item 1 or 2, wherein the acylacetonitrile compound is a compound represented by Formula (1) wherein X is a halogen atom or C₁₋₆ alkyl group.

4. The miticide according to item 1 or 2, wherein the acylacetonitrile compound is a compound represented by Formula (1) wherein Y is at least one member selected from the group consisting of halogen atoms and C₁₋₄ haloalkyl groups.

5. The miticide according to item 1, wherein the acylacetonitrile compound is a compound represented by Formula (1) wherein Z is an oxygen atom, X is a C₁₋₆ alkyl group, and Y is a C₁₋₄ haloalkyl group.

6. The miticide according to item 1, wherein the acylacetonitrile compound is a compound represented by Formula (1) wherein Z is an oxygen atom, R² is a (C₁₋₆ alkoxy)C₁₋₄ alkyl group, X is a C₁₋₆ alkyl group, and Y is a C₁₋₄ haloalkyl group.

7. The miticide according to any one of items 1 to 6 comprising 0.1 to 200 parts by weight of chlorfenapyr per 100 parts by weight of acylacetonitrile compound represented by Formula (1).

8. The miticide according to item 7 comprising 0.2 to 160 parts by weight of chlorfenapyr per 100 parts by weight of acylacetonitrile compound represented by Formula (1).

9. The miticide according to item 8 comprising 1 to 50 parts by weight of chlorfenapyr per 100 parts by weight of acylacetonitrile compound represented by Formula (1).

10. The miticide according to item 9 comprising 2.5 to 10 parts by weight of chlorfenapyr per 100 parts by weight of acylacetonitrile compound represented by Formula (1).

11. A method for controlling mites using an acylacetonitrile compound represented by Formula (1) and chlorfenapyr.

In the present specification, specific examples of groups represented by R², X, Y, Z, and R³ are as follows.

Halogen atoms include fluorine, chlorine, bromine, and iodine.

C₁₋₆ alkyl groups include, for example, C₁₋₆ linear and branched alkyl groups, such as methyl, ethyl, n-propyl, isopropyl, n-butyl, isobutyl, sec-butyl, tert-butyl, n-pentyl, isopentyl, neopentyl, n-hexyl, isohexyl, etc.

C₁₋₄ haloalkyl groups include, for example, C₁₋₄ linear and branched alkyl groups substituted by 1 to 9, and preferably 1 to 5, halogen atoms, such as fluoromethyl, chloromethyl, bromomethyl, iodomethyl, difluoromethyl, trifluoromethyl, 1-fluoroethyl, 2-fluoroethyl, 2-chloroethyl, 2,2,2-trifluoroethyl, pentafluoroethyl, 1-fluoropropyl, 2-chloropropyl, 3-fluoropropyl, 3-chloropropyl, 1-fluorobutyl, 1-chlorobutyl, 4-fluorobutyl, etc.

C₂₋₄ alkenyl groups include, for example, C₂₋₄ linear and branched alkenyl groups, such as vinyl, 1-propenyl, allyl, isopropenyl, 1-butenyl, 2-butenyl, 3-butenyl, 1-methyl-2-propenyl, 1,3-butadienyl, etc.

C₂₋₄ alkynyl groups include, for example, C₂₋₄ linear and branched alkynyl groups, such as ethynyl, 1-propynyl, 2-propynyl, 1-methyl-2-propynyl, 1-butynyl, 2-butynyl, 3-butynyl, etc.

C₁₋₆ alkoxy groups include, for example, C₁₋₆ linear and branched alkoxy groups, such as methoxy, ethoxy, n-propoxy, isopropoxy, n-butoxy, isobutoxy, sec-butoxy, tert-butoxy, n-pentyloxy, isopentyloxy, neopentyloxy, n-hexyloxy, isohexyloxy, etc.

C₁₋₄ alkyl groups include, for example, C₁₋₄ linear and branched alkyl groups, such as methyl, ethyl, n-propyl, isopropyl, n-butyl, isobutyl, sec-butyl, etc.

(C₁₋₆ alkoxy)C₁₋₄ alkyl groups include, for example, C₁₋₄ linear and branched alkyl groups substituted by a C₁₋₆ linear or branched alkoxy group, such as methoxymethyl, ethoxymethyl, n-propoxymethyl, isopropoxymethyl, n-butoxymethyl, isobutoxymethyl, sec-butoxymethyl, tert-butoxymethyl, n-pentyloxymethyl, n-hexyloxymethyl, methoxyethyl, ethoxyethyl, n-propoxyethyl, isopropoxyethyl, n-butoxyethyl, isobutoxyethyl, sec-butoxyethyl, tert-butoxyethyl, 3-methoxypropyl, 3-ethoxypropyl, 3-ethoxybutyl, etc.

C₁₋₄ alkylthio groups include, for example, C₁₋₄ linear and branched alkylthio groups, such as methylthio, ethylthio, n-propylthio, isopropylthio, n-butylthio, isobutylthio, sec-butylthio, tert-butylthio, etc.

(C₁₋₄ alkylthio)C₁₋₄ alkyl groups include, for example, C₁₋₄ linear and branched alkyl groups substituted by a C₁₋₄ linear or branched alkylthio group, such as methylthiomethyl, methylthioethyl, ethylthiomethyl, ethylthioethyl, ethylthiopropyl, ethylthiobutyl, n-propylthiomethyl, isopropylthiomethyl, n-butylthioethyl, etc.

Acylacetonitrile compounds represented by Formula (1) wherein Z is an oxygen atom are preferable.

Acylacetonitrile compounds represented by Formula (1) wherein R² is a (C₁₋₆ alkoxy)C₁₋₄ alkyl group are preferable.

Acylacetonitrile compounds represented by Formula (1) wherein X is a halogen atom or C₁₋₆ alkyl group are preferable.

Acylacetonitrile compounds represented by Formula (1) wherein Y is at least one member selected from the group consisting of halogen atoms and C₁₋₄ haloalkyl groups are preferable.

Among the acylacetonitrile compounds represented by Formula (1), those wherein Z is an oxygen atom, X is a halogen atom or C₁₋₆ alkyl group, and Y is at least one member selected from the group consisting of halogen atoms and C₁₋₄ haloalkyl groups are preferable.

When n is 1, Y is either a halogen atom or C₁₋₄ haloalkyl group. When n is 2 or 3, all of the n Y's may be either halogen atoms or C₁₋₄ haloalkyl groups, or the n Y's may consist of both halogen atom(s) and C₁₋₄ haloalkyl group(s).

Acylacetonitrile compounds represented by Formula (1) wherein Z is an oxygen atom, X is a C₁₋₆ alkyl group, and Y is a C₁₋₄ haloalkyl group are more preferable.

Acylacetonitrile compounds in which X representing a halogen atom is a chlorine atom or a C₁₋₆ alkyl group is an isopropyl or tert-butyl group are preferable, and those in which m is 1 are also preferable. Acylacetonitrile compounds in which X is at the 4-position of the phenyl ring are especially preferable.

Acylacetonitrile compounds in which Y representing a C₁₋₄ haloalkyl group is a trihalogenomethyl group, with a trifluoromethyl group being more preferable. Acylacetonitrile compounds in which n is 1 are preferable. Acylacetonitrile compounds in which Y is at the 2-position of the phenyl ring are especially preferable.

Acylacetonitrile compounds in which R² is a (C₁₋₆ alkoxy)C₁₋₄ alkyl group, Z is an oxygen atom, X is a C₁₋₆ alkyl group, Y is a C₁₋₄ haloalkyl group (trihalogenomethyl group), n is 1, and m is 1 are preferable. Acylacetonitrile compounds in which X is at the 4-position of one phenyl ring and Y is at the 2-position of the other phenyl ring are more preferable.

Acylacetonitrile compounds in which R² is a methoxyethyl group, Z is an oxygen atom, X is a tert-butyl group, Y is a trifluoromethyl group, n is 1, and m is 1 are further preferable. Acylacetonitrile compounds in which X is at the 4-position of one phenyl ring and Y is at the 2-position of the other phenyl ring are more preferable.

Acylacetonitrile compounds usable in the miticide of the present invention are known compounds. A production method thereof is disclosed in, for example, Japanese Unexamined Patent Publication No. 2002-121181.

Chlorfenapyr used in the miticide of the present invention is a compound known to have a mite controlling effect. Chlorfenapyr is represented by the formula: 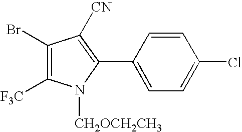
and is named 4-bromo-2-(4-chlorophenyl)-1-ethoxymethyl-5-trifluoromethylpyrrole-3-carbonitrile according to the IUPAC system.

It is essential to the present invention to use an acylacetonitrile compound of Formula (1) and chlorfenapyr in combination. The use of an acylacetonitrile compound of Formula (1) and chlorfenapyr in combination produces a significant mite controlling effect.

In the present invention, chlorfenapyr is usually used in a proportion of 0.1 to 200 parts by weight, preferably 0.2 to 160 parts by weight, more preferably 1 to 50 parts by weight, and particularly preferably 2.5 to 10 parts by weight, per 100 parts by weight of acylacetonitrile compound of Formula (1).

Although the miticide of the present invention may be composed entirely of an acylacetonitrile compound of Formula (1) and chlorfenapyr, it usually contains an acylacetonitrile compound and chlorfenapyr in conjunction with a solid carrier, liquid carrier, gaseous carrier (propellant), or like carrier, and as necessary, surfactants and other adjuvants.

Miticides of the present invention containing the aforementioned components may take the form of oils, emulsifiable concentrates, wettable powders, flowables, granules, powders, aerosols, fumigants, and the like, according to known preparation methods.

The total amount of the active ingredients, i.e., acylacetonitrile compound of Formula (1) and chlorfenapyr, usually accounts for 0.01 to 95 wt. % and preferably 0.1 to 50 wt. % of such a formulation.

Solid carriers usable for the preparation of such formulations include, for example, fine powdery, granular, and like forms of clays (kaolin clay, diatomite, water-containing synthetic silicon oxide, bentonite, fubasami clay, acidic clays, and the like); talc and derivatives thereof, ceramics, and like inorganic minerals (celite, quartz, sulfur, activated carbon, calcium carbonate, hydrated silica, and the like); chemical fertilizers (ammonium sulfate, ammonium phosphate, ammonium nitrate, urea, ammonium chloride, and the like); etc.

Liquid carriers include, for example, water; methanol, ethanol, and like alcohols; acetone, methyl ethyl ketone, and like ketones; benzene, toluene, xylene, ethylbenzene, methylnaphthalene, and like aromatic hydrocarbons; n-hexane, cyclohexane, kerosene, light oil, and like aliphatic and alicyclic hydrocarbons; ethyl acetate, butyl acetate, and like esters; acetonitrile, isobutyronitrile, and like nitriles; diisopropyl ether, dioxane, and like ethers; N,N-dimethylformamide, N,N-dimethylacetamide, and like acid amides; dichloromethane, trichloroethane, carbon tetrachloride, and like halogenated hydrocarbons; dimethylsulfoxide; soybean oil, cottonseed oil, and like vegetable oils; etc.

Gaseous carriers include, for example, butane gas, LPG (liquefied petroleum gas), dimethyl ether, carbon dioxide gas, etc.

Surfactants include, for example, sulfuric acid alkyl esters, alkylsulfonic acid salts, alkylarylsulfonic acid salts, alkylaryl ethers and polyoxyethylene adducts thereof, polyethylene glycol ethers, polyhydric alcohol esters, sugar alcohol derivatives, etc.

Adjuvants include, for example, fixing agents, dispersants, stabilizers, etc.

Fixing agents and dispersants include, for example, casein, gelatin, polysaccharides (starch, gum arabic, cellulose derivatives, alginic acid, and the like), lignin derivatives, bentonite, sugars, water-soluble synthetic polymers (polyvinyl alcohol, polyvinylpyrrolidone, polyacrylic acid, and the like), etc.

Stabilizers include, for example, acidic isopropyl phosphate (PAP), 2,6-di-tert-butyl-4-methylphenol (BHT), a mixture of 2-tert-butyl-4-methoxyphenol and 3-tert-butyl-4-methoxyphenol (BHA), vegetable oils, mineral oils, fatty acids and esters thereof, etc.

The miticide of the present invention can be used as is or diluted with, for example, water. The miticide can also be used as mixtures with other insecticides, nematocides, acaricides, fungicides, herbicides, plant growth control agents, synergists, soil conditioners, animal feeds, etc.,; and can be used simultaneously with such agents without mixing.

For agricultural use, the miticide of the present invention is usually used in an amount of 0.1 to 500 g, and preferably 1 to 100 g, per 1,000 m² of the area in need of mite control.

When the miticide of the present invention in the form of an emulsifiable concentrate, wettable powder, flowable, or the like is diluted with water, the concentration is usually 1 to 1,000 ppm, and preferably 10 to 500 ppm. The miticide of the present invention in the form of a granule, powder, or the like can be used as such without dilution with water.

The acylacetonitrile compound of Formula (1) is usually used in a concentration of about 0.5 to about 800 ppm, preferably about 12.5 to about 400 ppm, and more preferably about 100 to about 200 ppm. Chlorfenapyr is usually used in a concentration of about 0.1 to about 200 ppm, preferably about 0.1 to about 50 ppm, and more preferably about 0.4 to about 20 ppm.

The amounts and concentrations of these compounds, although exemplified above, can be suitably increased or decreased according to the type of formulation, time of application, place of application, method of application, kind of insect, severity of damage, etc.

In the embodiments of the present invention described above, the miticide contains both the acylacetonitrile compound of Formula (1) and chlorfenapyr. It is also possible that two separate compositions each containing either the acylacetonitrile compound of Formula (1) or chlorfenapyr are prepared in advance, and these compositions are then used sequentially or simultaneously when performing mite control, with simultaneous use of these compositions being preferable. In such a case, the acylacetonitrile compound of Formula (1) and chlorfenapyr may be used in the proportions described above.

### EFFECT OF THE INVENTION

The miticide of the present invention is effective, even at low doses, against harmful mites and the like. Examples of harmful mites are two-spotted spider mites (Tetranychus urticae Koch), carmine spider mites (Tetranychus cinnabarinus Boisduval), citrus red mites (Panonychus citri McGregor), Kanzawa spider mites (Tetranychus kanzawai kishida), European red mites (Panonychus ulmi Koch), broad mites (Polyphagotarsonemus latus Banks), pink citrus rust mites (Aculops pelekassi Keifer), bulb mites (Rhizoglyphus echinopus Fumouze et Robin), and like plant parasites. The miticide of the present invention produces a significant mite controlling effect against mites that are poorly sensitive to many chemicals as well as those that are sensitive to chemicals.

The miticide of the present invention brings about an excellent mite controlling effect against various mites even when used at low concentrations. The term “mite controlling effect” used herein means miticidal activities effective at any stage of the lifecycle of mites (e.g., egg, nymph and adult).

The miticide of the present invention exhibits an excellent mite controlling effect over a long period of 14 to 40 days.

Furthermore, the miticide of the present invention shows an excellent mite controlling effect against mites that have developed resistance to conventional miticides.

### BEST MODE FOR CARRYING OUT THE INVENTION

The present invention is described in more detail with reference to the following formulation examples and test examples, but the scope of the invention is not limited by these examples.

### FORMULATION EXAMPLE 1

### Flowable Preparations

Twenty parts by weight of methoxyethyl 2-(4-tert-butylphenyl)-2-(2-trifluoromethylbenzoyl)cyanoacetate (this compound is hereinafter referred to as “Compound A”), 2 parts by weight of polyoxyethylene allylphenyl ether potassium polyphosphate salt (trade name: Newkalgen FS-3K, manufactured by Takemoto Oil & Fat Co., Ltd.), 2 parts by weight of polyoxyethylene tristyrylphenyl ether (trade name: SOPROPHOR BSU, manufactured by Rhodia Nicca), 0.2 parts by weight of 1,2-benzisothiazolin-3-one (antiseptic agent, trade name: Proxel GXL(S), manufactured by Avecia kk), 0.3 parts by weight of a silicone-based antifoaming agent (trade name: PRONAL EX-300, manufactured by Toho Chemical Industry Co., Ltd.), 5 parts by weight of propylene glycol (antifreezing agent), and 60.5 parts by weight of water were mixed and pulverized by a Dyno-Mill according to a wet method. To this pulverized product was introduced 10 parts by weight of a 2% aqueous xanthan gum solution (thickener, trade name: Rhodopol 23, manufactured by Rhodia Nicca), to give a flowable preparation. This flowable preparation is hereinafter referred to as “Preparation A”.

“Kotetsu Flowable” (a flowable preparation containing chlorfenapyr in an amount of 10 wt. %) manufactured by Nippon Soda Co., Ltd., was obtained for use as a chlorfenapyr-containing flowable preparation. This flowable preparation is hereinafter referred to as “Preparation B”.

### FORMULATION EXAMPLE 2

### Flowable Preparation

Twenty parts by weight of Compound A, 2 parts by weight of chlorfenapyr, 3 parts by weight of polyoxyethylene tristyrylphenyl ether potassium phosphate salt (trade name: SOPROPHOR FLK, manufactured by Rhodia Nicca), 1 part by weight of dialkyl succinate sodium sulfonate salt (trade name: Newcol 291PG, manufactured by Nippon Nyukazai Co., Ltd.), 0.2 parts by weight of 1,2-benzisothiazolin-3-one (antiseptic agent, trade name: Proxel GXL(S), manufactured by Avecia kk), 0.3 parts by weight of a silicone-based antifoaming agent (trade name: PRONAL EX-300, manufactured by Toho Chemical Industry Co., Ltd.), 5 parts by weight of propylene glycol (antifreezing agent), and 58.5 parts by weight of water were mixed and pulverized by a Dyno-Mill according to a wet method. To this pulverized product was introduced 10 parts by weight of a 2% aqueous xanthan gum solution (thickener, trade name: Rhodopol 23, manufactured by Rhodia Nicca), to give a flowable preparation.

### TEST EXAMPLE 1

### Miticidal Test on Two-Spotted Spider Mites

Two-spotted spider mites from the Nagano prefecture, which are poorly sensitive to chemicals, were used as mite specimens. Preparation A and Preparation B were used as chemical specimens.

A plastic cup (trade name: KP-120, manufactured by Kohnoike plastic Co., Ltd.) was filled with tap water, and the plastic cup was covered with a lid having an incision therein. A piece of non-woven fabric (4.5×5.5 cm) was cut for about 4 cm parallel to its longer side 1 cm from the edge. The portion hanging loose was suspended inside the plastic cup through the incision. A kidney bean leaf (about 3.5×4.5 cm) was placed on the sufficiently soaked, non-woven fabric. Twenty female adults of two-spotted spider mites were released into each cup.

Preparation A and Preparation B each diluted with tap water to specific concentrations were mixed, and the mixture was sprayed in a volume of 2 ml using a spray tower (Potter Spray Tower, manufactured by Burkard Manufacturing Co. Ltd, at a spraying pressure of 5 lb/inch). The kidney bean leaf was placed in a thermostatic chamber having a temperature of 25±2° C. and a humidity of 60%. The numbers of live and dead mites were counted 2 days later. The mortality rate was calculated using the equation provided below.

For comparison, mortality rates were calculated in the same manner as above except that Formulation A and Formulation B each diluted with tap water to specific concentrations were used one without each other.
Mortality rate=(1−V/W)×100
where V is the survival rate in the treated area, and W is the survival rate in the untreated area.

Table 1 shows the results.

Furthermore, the effectiveness (E) anticipated from the miticide of the present invention was calculated using the Colby equation (Weeds 15, 20-22 (1967)) to obtain a mathematical effectiveness (%):
E=x+y−(x·y/100)
where E is the effectiveness expressed in % anticipated from Compound A and chlorfenapyr when used at concentrations of p and q, respectively; x is the effectiveness of Compound A when used at a concentration of p; and y is the effectiveness of chlorfenapyr when used at a concentration of q.

Table 1 also shows the mathematical effectivenesses (%) which are represented in numerical values placed in parentheses.

TABLE 1

| | | Concentration of Compound A (ppm) | | | | | |
|---|---|---|---|---|---|---|---|
| | | 0 | 12.5 | 25 | 50 | 100 | 200 |
| Concen- | 0 | | 19 | 45 | 48 | 25 | 66 |
| tration of | 0.4 | 0 | | | | | 82(66) |
| chlorfenapyr | 1 | 0 | 90(19) | 92(45) | 78(48) | 100(25) | 95(66) |
| (ppm) | 2 | 0 | 90(19) | 90(45) | 95(48) | 100(25) | 100(66) |
| | 5 | 0 | 100(19) | 100(45) | 100(48) | 100(25) | 100(66) |
| | 10 | 84 | 100(87) | 100(91) | 100(92) | 100(88) | 100(95) |

The mortality rates (%) shown in Table 1 are much greater than the mathematical effectiveness (%). It is clear from Table 1 that the use of acylacetonitrile and chlorfenapyr in combination significantly enhances a mite controlling effect beyond expectation of a person skilled in the art.

1. A miticide comprising:
(a) an acylacetonitrile compound represented by Formula (1): 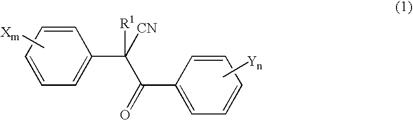
wherein R¹ is —C(O)ZR²; R² is a C₁₋₆ alkyl, C₁₋₄ haloalkyl, C₂₋₄ alkenyl, C₂₋₄ alkynyl, (C₁₋₆ alkoxy)C₁₋₄ alkyl, (C₁₋₄ alkylthio)C₁₋₄ alkyl, or benzyl group; Z is an oxygen or sulfur atom; X and Y independently represent a halogen atom or a C₁₋₆ alkyl or C₁₋₄ haloalkyl group; m and n independently represent an integer from 1 to 3; and each m X's and each n Y's may be the same or different, and
(b) chlorfenapyr.

2. The miticide according to claim 1, wherein the acylacetonitrile compound is a compound represented by Formula (1) wherein Z is an oxygen atom.

3. The miticide according to claim 1, wherein the acylacetonitrile compound is a compound represented by Formula (1) wherein X is a halogen atom or C₁₋₆ alkyl group.

4. The miticide according to claim 1, wherein the acylacetonitrile compound is a compound represented by Formula (1) wherein Y is at least one member selected from the group consisting of halogen atoms and C₁₋₄ haloalkyl groups.

5. The miticide according to claim 1, wherein the acylacetonitrile compound is a compound represented by Formula (1) wherein Z is an oxygen atom, X is a C₁₋₆ alkyl group, and Y is a C₁₋₄ haloalkyl group.

6. The miticide according to claim 1, wherein the acylacetonitrile compound is a compound represented by Formula (1) wherein Z is an oxygen atom, R² is a (C-₆ alkoxy)C₁₋₄ alkyl group, X is a C₁₋₆ alkyl group, and Y is a C₁₋₄ haloalkyl group.

7. The miticide according to claim 1, wherein the acylacetonitrile compound is a compound represented by Formula (1) wherein n is 1, m is 1, R² is a (C₁₋₆ alkoxy)C₁₋₄ alkyl group, Z is an oxygen atom, X is a C₁₋₆ alkyl group, Y is a C₁₋₄ haloalkyl group, X is at the 4-position of one phenyl ring, and Y is at the 2-position of the other phenyl ring.

8. The miticide according to claim 1, wherein the acylacetonitrile compound is a compound represented by Formula (1) wherein n is 1, m is 1, R² is a (C₁₋₆ alkoxy)C₁₋₄ alkyl group, Z is an oxygen atom, X is a C₁₋₆ alkyl group, Y is a trihalogenomethyl group, X is at the 4-position of one phenyl ring, and Y is at the 2-position of the other phenyl ring.

9. The miticide according to claim 1, wherein the acylacetonitrile compound is a compound represented by Formula (1) wherein n is 1, m is 1, R² is a methoxyethyl group, Z is an oxygen atom, X is a tert-butyl group, Y is a trifluoromethyl group, X is at the 4-position of one phenyl ring, and Y is at the 2-position of the other phenyl ring.

10. The miticide according to any one of claims 1 comprising 0.1 to 200 parts by weight of chlorfenapyr per 100 parts by weight of the acylacetonitrile compound represented by Formula (1).

11. The miticide according to claim 10 comprising 0.2 to 160 parts by weight of chlorfenapyr per 100 parts by weight of the acylacetonitrile compound represented by Formula (1).

12. The miticide according to claim 11 comprising 1 to 50 parts by weight of chlorfenapyr per 100 parts by weight of the acylacetonitrile compound represented by Formula (1).

13. The miticide according to claim 12 comprising 2.5 to 10 parts by weight of chlorfenapyr per 100 parts by weight of the acylacetonitrile compound represented by Formula (1).

14. A method for controlling mites using an acylacetonitrile compound represented by Formula (1) and chlorfenapyr.

15. The miticide according to claim 2, wherein the acylacetonitrile compound is a compound represented by Formula (1) wherein X is a halogen atom or C₁₋₆ alkyl group.

16. The miticide according to claim 2, wherein the acylacetonitrile compound is a compound represented by Formula (1) wherein Y is at least one member selected from the group consisting of halogen atoms and C₁₋₄ haloalkyl groups.

17. A method for controlling mites comprising applying a mixture of an acylacetonitrile compound represented by Formula (1) and chlorfenapyr in an effective amount to an area where mites are present.
